(19) United States
(12) Patent Application Publication
(10) Pub. No.: US 2010/0137493 A1
(43) Pub. Date: Jun. 3, 2010

(54) HIGH MINERAL CONTENT FILM FOR SEALING

(75) Inventor: Christopher R. Tilton, Laguna Hills, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SMART PLANET TECHNOLOGIES, INC., Irvine, CA (US)

(21) Appl. No.: 12/630,781

(22) Filed: Dec. 3, 2009

Related U.S. Application Data
(60) Provisional application No. 61/119,660, filed on Dec. 3, 2008.

(51) Int. Cl. C08K 3/26; C08K 3/34; C08L 23/06; C08K 3/40; C08K 3/36; C08L 31/04

(52) U.S. Cl. 524/427; 524/456; 524/451; 524/448; 524/449; 524/445; 524/450; 524/585; 524/570; 524/563

(57) ABSTRACT

A composition used to form thermoplastic films and coatings comprising a thermoplastic polyolefin and a ground natural mineral material wherein a film or coating formed of said composition heat seals at or above 200 degrees F. with a dwell time exceeding approximately 0.5 seconds, has a TAPPI T-525 Whiteness % over 78, a TAPPI T-425 Opacity % over 78, a post corona treated ASTM D-2578 dyne level over 38, a minimum moisture barrier transmission rate of 4.0 g/mil/100 sq. in./24 hrs. at 100 degrees F. at 90% relative humidity, and a minimum oxygen barrier of 350 cc/mil/100 sq. in/24 hrs. at 23 degrees C.

### CROSS-REFERENCE TO RELATED APPLICATIONS

This application claims the benefit of U.S. Provisional Application No. 61/119,660, filed Dec. 3, 2008, which is incorporated herein by reference in its entirety.

### BACKGROUND OF THE INVENTION

The present invention relates to thermoplastic polyolefin blends and more particularly, to thermoplastic polyolefin blends containing propylene homopolymers, propylene copolymers, propylene-ethylene copolymers, and ethylene vinyl acetate copolymers, medium and high density polyethylene, very low density polyethylene, and linear low density polyethylene and combinations thereof.

Related art includes film blends compatible with hat sealing, however, having a low percentage of natural mineral content (normally less than 20% by weight of the blend). Flexible films are used as printed and unprinted primary and secondary packaging materials designed retail, industrial, food, and commercial products into bags, sacks, pouches, wrappers, etc. Key attributes of hat sealed films can include substantial barrier protection, product protection and containment, preservation, shipping, storage and dispensing applications. Existing embodiments include flexible containers, generally enclosed on all but one side, having opening that are heat sealed. Other related packaging includes inner liners or bags used for packaging consumer, food, or industrial products. Glassine, greaseproof paper, waxed paper, or plastic films are frequently used for this purpose in order to create the required contact surface or to provide a suitable barrier. With greasy products, film liners preventing the staining or leaching of the bag material are used.

Considerations taken into account in the development of materials that can be sealed and formed into a package structure include the cost of resins and the cost to extrude, blow, or cast the resins into film or sheets. If desired, the films can be combined using lamination techniques. Many resins used in converted flexible film compounds are available to the market. Structural designs are often driven by barrier requirements between the enclosed product and the surrounding environment. In packaging, the term “barrier characteristics” is most commonly used to describe the ability of a material to stop or retard the passage of atmospheric gases, filled gases, water vapor, and volatile flavor and aroma ingredients. Barrier materials may serve to exclude or retain such elements without or within the package.

Moisture barrier, oxygen barrier, and grease resistance are considered key to many film performance requirements. Moisture barrier measurements are commonly stated as “Moisture Vapor Transmission Rate” as defined by ASTM F-1249, whose results are stated in g/mil/100 sq. in/24 hrs. @ 100 degrees F. at 90% RH (relative humidity). Depending upon thickness (also referred to as “caliper” herein), most films fall with the range of 0.1 to 6 g/mil/100 sq. in/24 hrs. @ 100 degrees F. at 90% RH. Oxygen barrier measurements are commonly stated as “Oxygen Gas Transmission Rate” as defined by ASTM D-3985, F-1307. F-2622, F-1927, whose results are stated in cc/mil/100 sq. in./24 hrs. @ 23 C. Depending upon caliper, most films fill within a range of 0.01 to 400 cc/mil/100 sq. in./24 hr. @ 23° C.

Water resistance is another key substrate barrier quality measurement. The “Cobb Test” is a common water absorption standard for paperboard, and an important tool measure post-extrusion coated paper containing materials. There are three exposure times used: 1 minute, 2 minutes, 3 minutes, and 30 minutes. The Cobb test (TAPPI-T-441) involves a known volume of water (100 ml) poured onto a specific area of the board's surface (100 cm²). The board is weighed before and after exposure and the difference between the two can then be expressed as the weight per unit area of water absorbed in that given time, so the lower the Cobb value, the better the result. For extrusion coated board e.g. acting as a common liner, a Cobb value above 60 and below 30 would be considered unacceptable.

Often sufficient barrier qualities can be achieved in design, however, the unprinted base film or base stock, which is the untreated film web-stock to which print, coatings, laminations, and other processes will be applied does not contain adequate printability or is prohibitively expensive. Printability is a key attribute for packages targeting the retail or point of sale industries. Printability is the ability of a material to yield printed matter of good quality. Printability is judged by the print quality and uniformity of ink transfer, rate of ink wetting and drying, ink receptivity, compressibility, smoothness, opacity, whiteness, color, resistance to picking, and similar factors, see chart 1 below for typical value ranges:

CHART 1

| Attribute | Value | Test Standard (TAPPI) |
|---|---|---|
| Whiteness % | 78 to 90+ | T-525 |
| Gloss Value % | >6 | T-480 |
| Opacity % | 78 to 90 | T-425 |
| Roughness-UM | >3 | |
| Surface Resistance | 10 (11^{th}) | T-527 |
| Dyne Level | 38 to 44 | D-2578_{(ASTM)} |

Printability is different than run-ability, which refers to the efficiency with which a substrate may be printed and handled at the press. Further, structural and printability factors influence the film's ability to be printed on specific equipment. It is generally preferred to print on a variety of equipment, maximizing quality of print and minimizing cost of manufacture. Printing techniques include flexographic, roto-gravure, heat-set, heat transfer, offset, offset lithography, non-contact laser, ink-jet, ultra-violet, hot stamp, screen, silk-screen. Another key factor is process-ability, which is the ease of which a material can be converted into high quality, useful products with standard techniques and equipment.

Also, environmental considerations are considered key. Minimizing energy use, green house gas emissions, water use, discharge, and maximizing recyclability and bio-degradability are considered very important. Packaging materials that contain mineral based materials are considered environmentally superior to plastics, most particularly to oil-based carbon materials synthetic resins and polymers. Additionally, the reduction of the weight of packaging is a primary consideration effecting eco-friendly objectives. Reduction is the first priority in a program to improve the environmental performance of a packaging system. Some definitions of source reduction also include the elimination of toxic materials used in packaging. Source reduction is one of the four R's of environmentally responsible packaging; the other being reuse, recycle, and recover.

Methods of enclosing and sealing flexible film structures are important manufacturing considerations. The efficiency, speed of production, and performance of the closure directly impact the quality and performance of the packaging. The sealing surface is the surface to which the seal will be made or the surface of the finish of the container on which the closure forms the seal. Often, when sealing materials together, a “sealer” material must be applied to one or more of the sealed surfaces. This coating is designed to prevent or retard the passage of one substance through another. For example, highly porous substrates might have sealer coats applied to reduce the absorption of adhesives, printing inks, or subsequent coatings. Within the packaging industry, several types of sealing methods are employed. The “L-Bar” sealer is a heat sealing device that seals a length of flat, folded film on the edge opposite the fold and simultaneously seals a strip across the width at 90 degrees from the edge seals. The article to be packaged is inserted between the two layers of folded film prior to sealing. Depending on the composition of the film and type of equipment used, seal pressures applied (from either the bottom or top sealing surface or both) to the film surfaces can vary between from around 15 psi to 45 psi and temperatures from between about 230 and 400 degrees F. with dwell times from about 0.5 seconds to 1.5 seconds.

When it is desired to cut the continuous length of sealed compartments into individual packages, a heated wire or knife is incorporated between two sealing bars that form the bottom of the L. These bars then make the top of the seal of the filled bag and the bottom seal of the next bag to be filled.

Heat sealing is any method of creating as seal using heat. These include fusing plastic together by melting together at the interface or by activating a pre-applied heat-activated adhesive substance. Hot wire sealing is a sealing method using a hot wire to heat and fuse the plastic material. The sealing action simultaneously cuts through and separates the film. Impulse sealing is a heat sealing technique in which a surge of intense heat is momentarily applied to the area to be sealed, followed immediately by cooling.

Solvent sealing is a method of bonding packaging materials, which depends of the use of small amounts of volatile organic liquid to soften the coating or surface of the material to the point where the materials will adhere. Ultrasonic sealing is the application of ultrasonic frequencies (20 to 40 kilohertz) to the materials being sealed together. The vibration at the interfaces generates enough localized heat to melt and fuse thermoplastic materials. Heat sealing may be effected by any of the conventional means known in the art, including hot wire, bar and dielectric.

As disclosed by Malcom Schard in U.S. Pat. No. 3,900,534, issued Aug. 19, 1975, depending upon various factors including thickness and type of sealer, using different blend combinations containing little or no significant mineral content, (shown below) considering a 1 mil film, dwell time is generally about from approximately 0.5 to 2 seconds and sealing temperature on or about 300° to 400° F. Heat seals are often formed utilizing a standard hot wire impulse sealer. The chart below (as disclosed by U.S. Pat. No. 3,900,534) shows an impulse of 125 volts applied across a 0.0036 inch diameter nichrome wire for an impulse dwell time of 0.2 seconds and a sealing jaw dwell time of 0.9 seconds. The applied pressure during sealing was about 20 p.s.i. Heat seal strength data presented in the following Table was determined utilizing a standard tensile testing machine, in accordance with A.S.T.M. Designation D 882. There was no significant mineral content in the film blend(s). See Table 1, below.

TABLE 1

| | Blend A | Blend B | Blend C |
|---|---|---|---|
| % Polybutene-1 | 10 | 15 | 20 |
| % Polypropylene | 90 | 85 | 80 |

Tensile Modulus (psi):

| | | | |
|---|---|---|---|
| MD | 241,500 | 1203,000 | 199,000 |
| TD | 237,800 | 187,000 | 184,000 |

Tensile Strength at Break:

| | | | |
|---|---|---|---|
| MD (psi) | 21,010 | 123,100 | 23,800 |
| TD (psi) | 24,000 | 19,900 | 20,100 |

% Elongation at Break:

| | | | |
|---|---|---|---|
| MD | 49 | 153 | 54 |
| TD | 68 | 58 | 84 |
| COF (ASTM D1894-6363 | 0.42 | 0.39 | 0.39 |

Seal Strength (psi):

| | | | |
|---|---|---|---|
| MD | 6,770 | 113,500 | 10,600 |
| TD | 5,640 | 11,500 | 10,800 |

Wherein:
MD = Machine Direction
TD = Transverse Direction

A problem that exists with prior production sealable packaging products and films is that the sealable composition does not incorporate environmentally friendly materials and designs, particularly with laminated structures and most particularly at low cost levels, offering affordability. High natural mineral content blends and films are exceptionally appealing for those purposes. Environmentally friendly materials can have desirable attributes such as biodegradability, compost-ability, a high recycled content, recycle-ability, and may also use less energy, pollute less, and generate fewer greenhouse gases in their manufacture than previous materials. Such environmentally friendly materials such as natural mineral content are increasingly in demand by consumers and retailers, and can be beneficial for manufacturers by reducing adverse environmental impact of the material.

Another significant problem that exists with prior flexible film packaging, laminations, and composites is the high concentration of expensive plastic and polymers required to achieve the sealing performance and specifications needed. Another problem is the need for laminating very expensive combinations of plastics, foils, coatings, metalized films, etc to achieve structural, barrier, sealing and printability aspects; this is the most significant problem within the art as polymer based materials can range from approximately $1,500 to $4,000 per ton of pre-converted resins, depending upon the material(s) used and the application. Additional problems include obtaining bright, white, opaque printing surfaces on barrier films without multi-layer laminations, corona treating for ink adhesion, or coating that treat film surfaces for quality lithography, flexographic, and offset printing. Other desired characteristics include sterilize-ability, anti-static/dissipative characteristics, and machine-ability during converting and printing.

The unique, mineral based materials that are also sealable can create excellent films (below 0.003 inches) and sheets (above 0.003 inches). The high mineral content materials can be fabricated from natural sources, such as limestone, clay, silica, mica, cellulose, and diatomaceous earth can be biodegradable and compostable, use less energy, no water, and fewer chemicals, and thus represents an advantage over other non-biodegradable and less environmentally friendly materials.

Polyolefin films are well known for their ability to return at least partially to their original structure when folded. However, there are many applications in the packaging industry where it is desirable to provide a film that can be folded and that retain structure. It is also desirable in such applications that the polyolefin film retains its strength, water resistance and rigidity. Although such products have been manufactured from polyolefins, heretofore such products have failed to contain high mineral content and also provide strength, fold-ability or both. It is well known that many applications require a film to heat seal to either itself or other packaging surfaces, making it possible to form a storage article. For environmental and sustainability reasons, it is also very desirable employing films that have high natural mineral content, reducing dependency on non-renewable sources such as polymers. Further, for flexo-graphic, roto-gravure and other printing purposes, opacity and whiteness it is highly desirable attribute of high mineral content films, improving quality of appearance. Finally, it is optimal to have a high mineral environmentally friendly packaging film that is opaque, white, will heat seal, surface energy at a least a 38 dyne level, and has proper dead-fold characteristics.

It is an object of this invention to provide heavy mineral loaded polyolefin compositions that can be extruded using blown and cast film technology into films that have little elastic recovery or memory and thus are able to retain most folds applied to the film. It is a further object of this invention to provide films that exhibit sufficient strength at the fold so that when they are folded they do not fail or split at the fold. Further, it is desirable to provide a film that has ample rigidity, allowing wrapping products using commercial wrapping and form-fill-seal machines. An additional object is to provide a packaging material that can easily and rapidly heat sealed. Finally, using predominantly natural mineral content formulations, it is an object of this invention to contain all previously mentioned characteristics providing optimum performance servicing multiple applications.

The products of the present invention are useful in many monolayer, coextruded, and composite packaging applications such that prior art film low or no mineral load products become obsolete. The present invention provides the additional properties characteristic of polyolefin and in particular barrier resistance to water and furthermore machine-able and printable. Additives known to improve UV light resistance can be incorporated in the films as well as other additives known in the industry, improving desired properties. The extruded films can be readily laminated to other polyolefin films or to paper products and can also be coextruded with other thermoplastic materials.

### SUMMARY OF THE INVENTION

The present invention specifically addresses and alleviates the above-identified deficiencies in the art. In this regard, the present invention is directed to a unique environmentally friendly high mineral loaded flexible film blend for use as a suitable sealing material to itself and other substrates such that when exposed to sealing techniques known to the art, e.g. heat and ultrasonic sealing methods, thus fabricating storage articles for retail, consumer, medical and industrial applications. The sealable mineral heavy film can also be printed using a variety of printing techniques with or without pre-treatments including roto-gravure, heat set, heat transfer, screen, silk screen, laser offset, flexographic, and UV. Further the heat sealable film structure has mass, stiffness, and tensile strength and other characteristics that allow it to be readily machined into desired storage article forms, such as storage boxes pouches, sleeves, bags, gusseted bags, side gusseted bags, sacks, gusseted stand up, re-closable stand-up, labels, shelf papers, and many other sealed flexible film constructions within the art, all of which have high durability as well as good moisture resistance and biodegradability. Further, the sealable flexible film, can be sealed to closure using and standard sealing method consistent with sealing thermoplastic containing materials. This substrate offers the benefits of density and weight, however, because the low cost per ton of earth based minerals, it does not have the high costs per ton normally associated with plastic and polymer films that are currently sealable and known to the art, thus allowing favorable dollar yields per MSI. The high mineral substrate, after sealing, can perform as a low cost sterilize-able as well as an anti-static, substantially non electrical, conductive barrier film.

Additional objects of the present invention are accomplished by polyolefin compositions containing varying compositions of high and low molecular weight polyolefin components, in some cases comprising none or some level of magnesium silicate, and in all cases very high levels of diatomaceous earth mineral or metal content. With some high molecular weight resins, the low molecular weight component may not be necessary. Additionally, the composition may contain additives enhancing or providing desirable attributes to the composition, including but not limited to fillers, pigments, colorants, UV stabilizers, anti-friction and anti-blocking additives, anti-static agents, oxidation and heat stabilizers as well as other agents which aid in the fabrication of the film can be used. The films of the present invention can be prepared using standard film extrusion methods and equipment and can be manufactured over a wide range of gauges. The films of the present invention can further be coextruded with other thermoplastic resins or laminated to different substrates such as polyolefin films, paper, cardboard, fiber composites, non-woven fabrics and plastic foams. The present invention also relates to films obtained by the extrusion of novel compositions of the present invention and to the processes employed to manufacture such.

### DETAILED DESCRIPTION OF PREFERRED EMBODIMENTS

As employed in one aspect of the present invention includes a high density polyethylene (“HDPE”) having a density preferably in the range of 0.945 to 0.965 g/cm³ and a melt index (ASTM D1238) below 0.1 g/10 min, and preferably above 0.01 g/10 min, and preferably in the range of 0.04 to 0.057 g/10 min. The melt index is deemed to be inversely proportional to the molecular weight. The HDPE resins employed in embodiments of the present invention are commercially available. At higher melt index the films lose some of their strength whereas at the lower melt index the compositions become more difficult to extrude. At lower densities films of the compositions of embodiments of the invention lose rigidity and at higher densities the compositions of the present invention are difficult to extrude in standard commercial equipment. Also, ethylene-vinyl acetate copolymer comprising 10 to 35% by weight of the blend having a vinyl acetate content from about 2% to 30% of the blend and a melt index of 0.75 to 3.0 (ASTM 1238) and density of from about 0.916 to 0.926 g/cm³ (ASTM 1238) are preferred alternatives.

The low molecular weight polyolefin component is preferably a linear low density polyethylene (LLDPE) or low density polyethylene (LDPE) of either hexene or butene grades having a density in the range of 0.916 to 0.926 g/cm³ and from 0.95 to 2.0 g/cm³ and a melt index (ASTM D-1238) of 0.75 to 3.0 g/10 min. Also, such resins are commercially available and generally are co-polymers of ethylene and either octane or butene. If the molecular weight and the density are higher, the resins are more difficult to uniformly disperse in the matrix of the HDPE and if the molecular weight and density are further reduced the mechanical properties of the extruded films of the compositions will deteriorate.

The HDPE can be employed in embodiments of the composition of this invention in the range of 10% to 48% and preferably in the range of 10% to 30% by weight of the total composition. LLDPE is employed in the range of 0% to 48% and preferably in the range of 29% to 48% by weight of the total composition. These ranges combine the resin components in an optimum combination of physical properties of films extruded from such. Further, in some combinations, HDPE can be employed within a melt index of 0.04 to 0.30 g/10 minutes per ASTM D1238 and densities from 0.935 to 0.960 g/cm³.

The magnesium silicate employed in embodiments of the present invention is used to reduce the elastic recovery of the polyolefin composition and can be manufactured, or naturally occurring magnesium silicate itself, such as fosterite, or can be a hydrated magnesium silicate, such as Mg₃Si₄O₁₀ (OH)₂, or can be a magnesium silicate that contains some other element such as iron in its crystal structure. The hydrated magnesium silicate is the preferred additive. The magnesium silicate and other minerals used in the composition of the embodiment generally have a particle size below 15 microns and is preferably used in a particle size of one to five microns. Depending of the weight of the mineral load, the particulate magnesium silicate is employed in the range of 0 to 15 weight % and preferably in the range of 1.5 to 5 weight %. A too high a mineral or magnesium concentration in the extruded film will have inadequate mechanical properties whereas at too low concentrations the film will not easily fold. The magnesium silicate can be coated with a silanes to improve its bonding and dispensability properties in the polyolefin matrix. Suitable silanes are well known in the art.

The inorganic natural mineral component is preferably a ground calcium carbonate. The calcium carbonate is generally employed of about 45 to 65 by weight % and preferably in the range of about 50 to 65 by weight %. Instead of calcium carbonate, similar alkaline earth carbonate could be uses as well as diatomaceous earth such as clay, mica, silica, and other minerals known to the art. The calcium carbonate should be finely divided, preferably less than 10 microns, to allow for a uniform distribution in the polymer blend and preferably particle sizes falling into the same approximate size as the magnesium silicate. Any additional additives such as pigments, stabilizers and anti-blocking agents are those generally employed in the art for such purposes and are used in the recommended or established concentrations for polyolefins. These additives will complete 100% of the formulation.

The foldable and heat sealable films in accordance with aspects of the present invention can be prepared by first dry blending all of the ingredients and then using standard extrusion methods developed for polyolefin films, e.g., cast or blown packaging films. Preferably the films are prepared by the blown film method in which the blended ingredients are fed to a single or double screw extruder but preferably one that contains a feed section, a compression section, and a metering section in which further blending and heating of the blended material takes place resulting in a uniformly blended melt. The molten material is then extruded through an annular die and blown into a tube causing optional biaxial orientation to take place. The pressure in the extruder is given by the die diameter, its die gap is controlled by the speed of the screw (rpm). An air ring surrounding the annular die that blows cold air on the extrudate at variable speeds further controls the cooling of the extruded film. The speed of the nip rolls and the quantity of air within the bubble accomplish the desired degree of orientation.

In general the extrusion is conducted at temperatures of at least 20 degrees Celsius above the melting point of the blend, which is in the range of 165 to 230 degrees C. When using a single screw extruder and a screw design most commonly used for polyethylene the extruder screw is generally rotated at a rate of 45 to 95 rpms. The key to extrusion rate is to allow for thorough mixing and uniform heating of the film composition. The annular extrusion die is generally maintained at higher temperatures to allow for a proper and uniform drawdown of the molten blend. Die openings and draw down orientation depends on the final desired thickness and degree of orientation in the film. The blow up ratios that can be employed in the process can vary from 1.5 to 6.0. The bubble is drawn for a distance that allows the film to cool sufficiently so that when it is collapsed it does not sea to itself Draw down speeds are selected to provide the desired linear orientation and thickness of film and in general range from 0.5 to 70 m/min. The compositions in accordance with aspects of the present invention may also be coextruded with such resins as polypropylene and other polyolefins using standard coextrusion dies. The obtained films can be laminated to other materials, applying standard lamination processes. The invention is further demonstrated by the following example, which is considered to be illustrative and not limiting.

### Example 1

Fifteen parts of HDPE can be loaded into a dry mixer, having a density of 0.953 and a melt index, as measured by ASTM D1238, of 0.05 g/10 min in pellet form, 30 parts of a LLDPE with a density of 0.918 and a melt index of 1.10 g/10 min also as measured by ASTM D1238 and also in pellet form. One part of finely divided hydrated magnesium silicate, Mg₃Si₄O₁₀ (OH)₂, 51 parts of finely divided commercially available calcium carbonate, 1.5 parts of a commercially available anti-static agent, and 1.5 parts or white pigment such as Ti0₂ are added and dry blended until a uniform dry mixture is obtained. The blended process keeps moisture content to slightly above zero and packaged to prevent moisture leaching into the formula. The resulting blend, with moisture mitigation procedures in place to help prevent lensing, is automatically fed into the hopper of a blown film line commonly known in the art.

The resulting film has a thickness range of about 25 to about 80 microns and is semi-opaque. The film can be folded and retain fold with little elastic recovery and without cracking or splitting. It is water resistant and can be heat sealed. Other estimated properties of the film are ultimate tensile strength on or about 2,500 MD and on or about 1,600 TD (D-882), elongation 190% MD and 30% CD (D-882), and opacity 71% (D-1003) and coefficient of friction (COF) of on or about 0.33.

### Example 2

A blend in the form of a premixed compound, which the polyethylene content with a melt index of 0.06 g/10 min. is 40% by weight content of an ethylene/propylene copolymer with a melt index of 3 g/10 min. and calcium carbonate with particle sizes less than 7 microns comprising 50% by weight of the blend. The blend also containing 5% by weight titanium dioxide (TiO₂) with other additives completing the blend. The process keeps moisture content to slightly above zero and packaged to prevent moisture leaching into the formula. The blend, with moisture mitigation procedures in place to help prevent lensing, is automatically fed into the hopper of a blown film line commonly know in the art. Post extrusion, the film is subsequently heated and stretched 5 times MD length and 8 times in the CD direction, the resulting film had a thickness of 25 to 50 microns and was semi-opaque. The film can be folded and retained fold with little elastic recovery and without cracking or splitting. It was water resistant and can be heat sealed. Other estimated properties of the film were ultimate tensile strength on or about 3,500 MD and on or about 2,200 TD (D-882), and opacity 74% (D-1003) and coefficient of friction (COF) of on or about 0.37.

### Example 3

A blend in the form of a premixed compound, which contains an ethylene-vinyl acetate copolymer comprising 15% by weight % of the total compound, having a vinyl and a melt index (ASTM 1238) of from about 0.1 to about 1.0 (ASTM 1238), and a high density polyethylene having a density of from about 0.94 to about 0.96 g/cm³ and a melt index of from about 0.04 to about 0.01 (ASTM 1238) comprising 30% by weight % and calcium carbonate with particle sizes less than 5 microns comprised 50% by weight of the blend. Other additives found common to the art comprised the remaining portion of the blend, including 3% Titanium Dioxide, Ti0₂. The process kept moisture content to slightly above zero and packaged to prevent moisture leaching into the formula. The blend, with moisture mitigation procedures in place to help prevent lensing, was automatically fed into the hopper of a blown film line commonly known in the art. The resulting film has a thickness range of from about 25 to 100 microns and semi-opaque. The film could be folded and retained fold with little elastic recovery and without cracking or splitting. It was water resistant and heat sealable. Other estimated properties of the film were 82% opacity (TAPPI T-425), 83 whiteness % (TAPPI T-525) and gloss value % of at least 65 (TAPPI T-480) coefficient of friction (COF) of on or about 0.36 (D-1984).

There has therefore been provided blends designed for use in cast or blown film extrusion as well as extrusion coating processes and henceforth used in films forming monolayer, coextruded, bi-axially stretched, and laminated films with physical characteristics suitable for heat seal and folding packaging applications. Such films are useable for forming heat sealed packaging articles for the liquid, baked goods, mixes, beverages, confectionary products, frozen, dry shelf, diary, meats, seafood, anti-static, dissipative, snack, shipping, sack and bagged goods industries.

The present invention provides an unexpectedly unique and environmentally friendly heavy mineral containing film structure that is economically and effectively formed into a storage articles through industry standard heat sealing methods. Through the employment of sealing methods, the material forms flexible and semi-rigid storage articles at equal or lower costs to prior art solutions while providing a mineral containing surface that is a very smooth, has comparatively high plasticity, and having a sufficient opacity and whiteness rendering it a high quality printing that readily accepts coating and inks, therefore, rendering it highly attractive to consumers. Other advantages include environmentally attractive features such sustainable content versus high polymer containing films.

The foregoing examples are demonstrative of the compositions of films of the present invention and not intended to be limiting. Various process modifications and additives commonly employed for certain film preparation and properties may be similarly employed in the composition of the present invention.

What is claimed is:

1. A composition used to form thermoplastic films and coatings, the composition comprising:
a thermoplastic polyolefin selected from the group consisting of high density polyethylene, ethylene-vinyl acetate copolymer, low density polyethylene, linear low density polyethylene, ethylene/propylene copolymer, and combinations thereof; and
a ground natural mineral material selected from the group consisting of ground calcium carbonate, magnesium silicate, talc, diatomaceous earth, mica, silica, glass, clay, zeolytes, and slate;
wherein a film or coating formed of said composition heat seals at or above 200 degrees F. with a dwell time exceeding approximately 0.5 seconds, has a TAPPI T-525 Whiteness % over 78, a TAPPI T-425 Opacity % over 78, a post corona treated ASTM D-2578 dyne level over 38, a minimum a moisture barrier transmission rate of 4.0 g/mil/100 sq. in./24 hrs. at 100 degrees F. at 90% RH, and a minimum oxygen barrier of 350 cc/mil/100 sq. in/24 hrs. at 23 degrees C.

2. The composition of claim 1, further comprising an additive selected from the group consisting of fillers, pigments, titanium dioxide, colorants, UV stabilizers, an anti-friction agent, an anti-blocking agent, an anti-static agent, oxidation stabilizers, heat stabilizers, and combinations thereof.

3. The composition of claim 1, wherein the polyolefin comprises 10% to 48% by weight high density polyethylene.

4. The composition of claim 1, wherein the polyolefin comprises 10% to 30% by weight high density polyethylene.

5. The composition of claim 1, wherein the polyolefin comprises 10% to 35% by weight ethylene-vinyl acetate.

6. The composition of claim 1, wherein the polyolefin comprises 29% to 48% by weight low density polyethylene.

7. The composition of claim 1, wherein the polyolefin comprises 29% to 48% by weight linear low density polyethylene.

8. The composition of claim 1, wherein the polyolefin comprises 40% by weight ethylene/propylene copolymer.

9. The composition of claim 1, wherein the ground natural mineral material comprises 45% to 65% by weight ground calcium carbonate.

10. The composition of claim 1, wherein the ground natural mineral material comprises 50% to 65% by weight ground calcium carbonate.

11. The composition of claim 1, wherein the ground natural mineral material comprises up to 15% by weight magnesium silicate.

12. The composition of claim 1, wherein the ground natural mineral material comprises 1.5% to 5% by weight magnesium silicate.

13. The composition of claim 1, wherein the ground natural mineral material comprises 1% by weight magnesium silicate.

14. A composition used to form thermoplastic films and coatings of from about 0.005″ to about 0.035″ thickness, the composition comprising by weight of the total composition:
at least one of up to 60% of an ethylene/propylene copolymer with a melt index of 0.75 to 4 g/10 minutes (ASTM D1238), up to 60% of low density polyethylene having a density of 0.916 g/cm³ to 0.926 g/cm³ and a melt index, as determined by ASTM D1238, of 0.75 to 3.0 g/10 min, up to 60% of linear low density polyethylene having a density of 0.916 g/cm³ to 0.926 g/cm³ and a melt index, as determined by ASTM D1238, of 0.75 to 3.0 g/10 min., up to 60% of high density polyethylene having a density of 0.937 g/cm³ to 0.953 g/cm³ and a melt index as determined by ASTM D1238 of 0.04 to 0.030 g/10 min., and up to 50% ethylene-vinyl acetate copolymer having a density of from about 0.916 to 0.926 g/cm³ and a melt index, as determined by ASTM D1238, of 0.75 to 3.0 g/10 min.;
40 to 65% of less than 15 micron sized ground natural mineral content;
0 to 30% titanium dioxide, TiO₂; and
0 to 10% magnesium silicate;
wherein, said composition forms a film that heat seals at or above 200 degrees F. with a dwell time exceeding approximately 0.5 seconds; and
wherein, said composition forms a film having a TAPPI T-525 Whiteness % over 78; and
wherein, said composition forms a film having a TAPPI T-425 Opacity % over 78; and
wherein, said composition forms a film having a post corona treated ASTM D-2578 dyne level over 38; and
wherein, said composition forms a film having a minimum a moisture barrier transmission rate of 4.0 g/mil/100 sq. in./24 hrs. at 100 degrees F. at 90% RH; and
wherein, said composition forms a film having a minimum oxygen barrier of 350 cc/mil/100 sq. in/24 hrs. at 23 degrees C.

15. The composition of claim 14, wherein the composition further comprises from 0.5% to 3% additives.

16. The composition of claim 14, wherein the composition further comprises from 0.5% to 1.5% of an antifriction agent.

17. The composition of claim 14, wherein the composition further comprises from 0.5% to 1.5% of an anti-blocking agent.

18. The composition of claim 14, wherein the composition further comprises from 1 to 3% to magnesium silicate.

19. The composition of claim 14, wherein the natural mineral content comprises talc, diatomaceous earth, mica, silica, glass, clays, zeolytes, and slate.

20. The composition of claim 14, wherein the composition further comprises heat stabilizer additives.

21. The composition of claim 14, wherein the composition is coextruded with other thermoplastic resins.
